(19) United States
(12) Patent Application Publication
(10) Pub. No.: US 2023/0230759 A1
(43) Pub. Date: Jul. 20, 2023

(54) ELECTRICAL APPLIANCE WITH MECHANICAL DECOUPLING BETWEEN THE ACTIVE PART AND BOILER

(71) Applicant: SIEMENS AKTIENGESELLSCHAFT, München (DE)

(72) Inventors: Aime Mbuy, Nürnberg-Weiherhaus (DE); David Weber, Weilersbach (DE); Viktor Wins, Wilhermsdorf (DE); Christer Vogt, Langensendelbach (DE)

(21) Appl. No.: 18/011,273

(22) PCT Filed: Jun. 19, 2020
(86) PCT No.: PCT/EP2020/067202

§ 371 Date: Dec. 19, 2022

(51) Int. Cl. H01F 27/30; H01F 27/02; H01F 27/32; H01F 27/24

(52) U.S. Cl. CPC H01F 27/306; H01F 27/022; H01F 27/321; H01F 27/24

(57) ABSTRACT

An electrical appliance for connecting to a high voltage includes an active part, which is provided with a magnetizable core and at least one winding assembly, surrounding a respective core section of the core and having windings that are inductively coupled to one another. A tank, which can be filled with an insulating fluid, encases the active part. The tank has two end casings and a central part arranged between the end casings. The electrical appliance is compact and has a low tare weight. The active part is mechanically connected to the boiler only at the end casings and the end casings are supported on fasteners. The central part is produced from a light material.

The invention relates to an electrical appliance for connecting to a high voltage, having an active part which comprises a magnetizable core and at least two winding assemblies which enclose in each case one core portion of the core and have windings that are inductively coupled to one another, and having a tank which is able to be filled with an insulating fluid and in which the active part is completely disposed, wherein the tank has two end casings and a central part disposed between the end casings.

Such an electrical appliance is already known from WO 2008/184775 A1. Shown therein is a railway transformer which has an active part and a tank in which the active part is completely disposed. The active part comprises a core having two core limbs which are in each case enclosed by two windings that are disposed so as to be mutually concentric. The housing has a central part which surrounds the external contour of the windings so as to have a shape complementary to the latter. In other words, the central part forms two hollow cylinders with partially overlapping internal volumes. As a result of the design embodiment with partially complementary shapes, the internal volume of the tank, and thus the oil volume, can be reduced.

WO 2016/038222 A1 discloses a railway transformer having an active part and a tank, wherein the core of the active part is disposed completely outside the housing. The railway transformer here is fastened to the rail vehicle by way of the core so that no high forces are introduced into the housing. Therefore, the housing can be made from a lightweight material such as plastics material, for example.

Railway transformers are provided for assembly on a rail vehicle such as, for example, a locomotive or a railcar. Said railway transformers serve for providing a desired traction voltage for driving the locomotive or the railcar as a function of different input voltages. Railway transformers known from the prior art have a metallic tank which is connected to the earth potential and is filled with an insulating fluid, for example an ester liquid. The so-called active part of the transformer, which comprises a core composed of magnetizable laminations and at least two windings that concentrically enclose a portion of the core, is disposed in the tank. For connecting the transformer to a high voltage, the tank is equipped with feedthroughs.

The previously known electrical appliance has the disadvantage that the active part is connected to the fastening means across the entire tank. Therefore, the entire tank has to be made from a mechanically stable material such as steel, for example. However, this increases the dead weight of the electrical appliance. However, a compact, lightweight construction is desirable in particular for railway applications.

It is, therefore, an object of the invention to provide an electrical appliance of the type mentioned at the outset, in which the weight of the active part is not introduced into the fastening means across the entire tank.

The invention achieves this object in that the active part is mechanically connected to the tank only at the end casings, and the end casings are supported on fastening means, wherein the central part is made from a lightweight material.

A lightweight material in the context of the present invention is any material having a dead weight that is lower than that of steel by a factor of 2. Steel thus has a density of 7.85-7.87 g/cm³. Materials having a density of less than 3.9 g/cm³ are lightweight materials in the context of the invention. Examples of such lightweight materials include aluminum, plastics materials and fiber-reinforced plastics materials. The central part preferably is composed substantially of a glass-fiber-reinforced plastics material having a density of 2.5 g/cm³.

In the context of the invention, the active part is connected to the fastening means by way of the end casings of the tank. The high weight of the active part in the context of the invention is therefore introduced into the fastening means only by way of the end casings. In the context of the invention, any mechanical stress of the central part is avoided. This enables the use of a central part of a lightweight material, and in this way the reduction of the dead weight of the electrical appliance according to the present invention.

A magnetizable material here is understood to be a ferromagnetic material such as iron, for example.

In the context of the invention, windings of a winding assembly are preferably disposed so as to be mutually concentric. For example, an outer winding of the winding assembly, as a primary winding, is conceived for higher voltages than a secondary winding which is disposed further inward, or vice versa. Besides a primary winding and a secondary winding, each winding assembly may also have further windings such as, for example, an auxiliary operative winding, a bank winding, or the like.

The support frame advantageously has two longitudinal supports, two transverse supports extending between the latter, wherein each end casing is supported on one of the transverse supports. In this refinement of the invention, the fastening means are embodied as a support frame which in terms of the construction thereof is simple and, therefore, can be produced in a cost-effective manner. The longitudinal supports and transverse supports must have the required mechanical strength in order for the electrical appliance according to the invention to be securely held on a rail vehicle, for example. The support frame is thus assembled from steel profile supports as longitudinal supports and transverse supports, for example.

In one preferred variant of the invention, the core has two core limbs which run so as to be mutually parallel and which are in each case enclosed by a winding assembly, wherein the core limbs are connected to one another by a lower and an upper yoke. A closed ferromagnetic circuit is configured in this way.

In this variant of the invention, two winding assemblies having, for example, a total of four windings are thus provided, wherein two windings are in each case disposed so as to be mutually concentric and enclose a common limb of the core as the core portion. Here, these are, for example, an inner low-voltage winding and a high-voltage winding that encloses the low-voltage winding. The core furthermore has a further limb which is likewise enclosed by a low-voltage winding or high-voltage winding, respectively. The two low-voltage and high-voltage windings here are connected in series, for example. The core limbs that extend in each case through one of the two winding assemblies are therefore aligned so as to be mutually parallel. The internal wall of the central part of the tank follows the external contour of the outer windings of the respective winding assembly across the entire contour.

Of course, three or more limbs may also be provided in the context of the invention, wherein each limb is equipped with one winding assembly which is composed of two or a plurality of windings.

The lower yoke and the upper yoke are advantageously connected in each case to the lower end casing and the upper end casing by way of spacers, wherein the spacers are disposed in the interior of the respective end casing. The core is preferably composed of laminations which bear on one another in a planar manner and are mutually braced. Press frames which are disposed on the upper and the lower yoke are provided for bracing the laminations. Each press frame comprises two press supports that are disposed on both sides of the yoke. Clamping bolts which are equipped with windings serve for bracing the press supports.

The lower and the upper yoke by way of the clamping frame thereof preferably bears on spacers and/or is mechanically fastened to the latter such that the yokes, given a horizontal disposal of the railway transformer, are held in a centric position in the internal volume of the respective end casing.

According to a respective refinement, each spacer which is disposed in the interior of the respective end casing is connected to a fastening plate disposed outside the respective end casing. This construction has proven to be mechanically stable and at the same time simple and cost-effective.

It is expedient here for each fastening plate to be connected to the fastening means, thus for example to a transverse support of a support frame.

The end casings are advantageously also adapted to the active part portions that are disposed in the internal volume of said end casings. According to this refinement of the invention, the tank, even outside the central part thereof, at least in terms of the inner design thereof not only fits snugly on the external contour of the outer windings. Rather, the tank is also designed so as to complement the shape of further portions of the active part that likewise establish the external contour of the active part.

The upper yoke and the lower yoke, conjointly with the respective press frame, define the external contour of the active part which is not defined by the windings. While the windings do, however, define a typically cylindrical external contour, the remaining external contour of the active part significantly deviates therefrom. Adapting the shape of the tank so as to complement this somewhat more complex external contour is therefore limited to forming a box-shaped envelope. This means that the tank in terms of the design embodiment thereof does not reproduce each screw or each pin but reproduces the entire portion by way of a box-shaped and partially rounded contour. This box-shaped contour then delimits an internal space which enables said active part portions to be received with the necessary electrical strength but at the same time limits the internal volume of the tank to a minimum.

The end casings are advantageously made from a metal or a metallic alloy. It is particularly preferable for the end casings to be made from steel. Steel has a high mechanical strength.

The end casings are in each case expediently designed so as to be box-shaped. A box-shaped design can be mass-produced. Adapting to the respective, individually produced active part can be dispensed with in this variant of the invention. Further costs can be saved in this way.

At least one end casing advantageously has a viewing window and/or a hand opening. According to this refinement of the invention, the electrical appliance can be produced and serviced in a simple manner.

The electrical appliance is preferably a railway transformer.

In one preferred variant of the invention, the core has two core limbs which are connected to one another by way of an upper and a lower yoke, wherein each core limb extends through a hollow member and is surrounded by a winding assembly.

The central part advantageously has two flange portions of planar design, each hollow member extending therebetween, and each flange portion being mechanically connected in a releasable manner to a flange portion of one of the end casings, wherein sealing means are disposed between the mutually facing flange portions. The central part and the end casings have to be connected to one another in a fluid-tight manner in order to reliably prevent the undesirable leakage of insulating fluid from the tank. Particularly suitable for this purpose is a flange connection. It is, therefore, advantageous for the central part on the two end sides thereof to form flange portions that extend orthogonally outward in the radial direction from the external contour. In the context of this refinement, the end casings form a corresponding flange portion which lies exactly opposite one of the two flange portions of the central part. The flange portions can therefore be placed on one another and mutually compressed, wherein the sealing means, for example an encircling O-ring that is circumferentially closed, ensures that there is no leakage of insulating fluid. The compressing can be performed by means of a screw connection, for example, wherein the screws of said screw connection penetrate through bores in the flange portions and engage in a lock nut.

According to one respective refinement, at least one end casing, for a transverse support of the fastening means on which said end casing bears, forms a counter bearing for delimiting a movement in the axial direction. The fastening means here are expediently embodied as support frames. The fastening means preferably comprise two transverse supports. The spacing of these transverse supports is adapted to the dimensions of the tank in the longitudinal direction. At least one end casing here, preferably both end casings, form(s) in each case a counter bearing which lies opposite a narrow side of the respective transverse support so as to form an exact fit with the latter. The counter bearing in this instance limits a movement of the tank in the axial direction, in addition to the fastening to the transverse support.

Further expedient design embodiments and advantages of the invention are the subject matter of the description hereunder of exemplary embodiments of the invention with reference to the figures of the drawing, wherein identical reference signs relate to equivalent components, and in which:

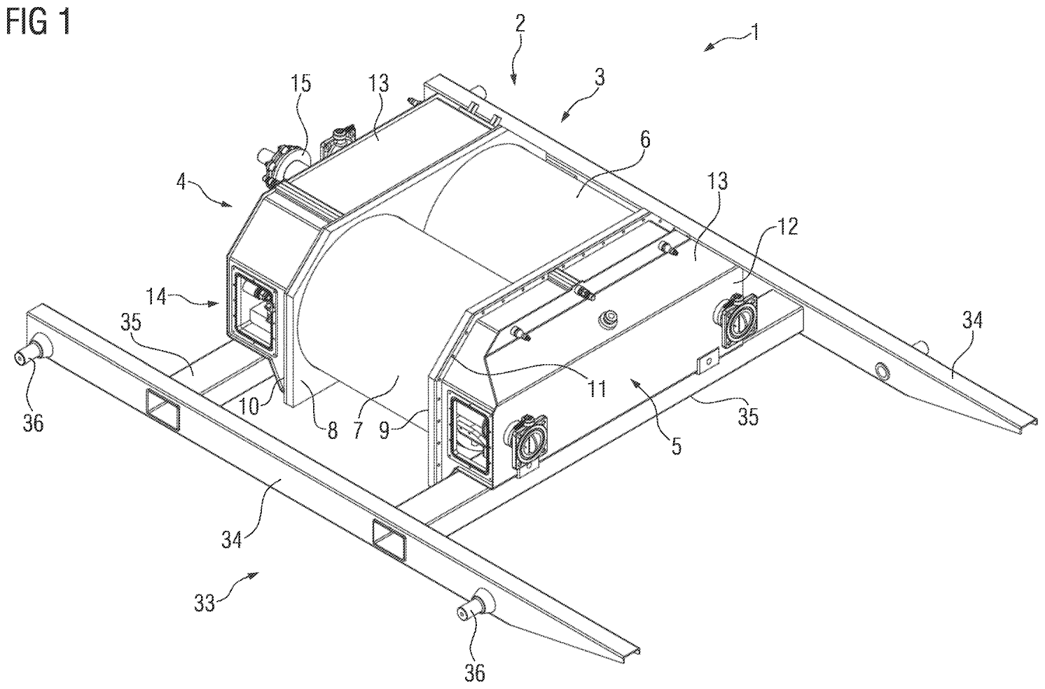

FIG. 1 shows an exemplary embodiment of the electrical appliance according to the invention;

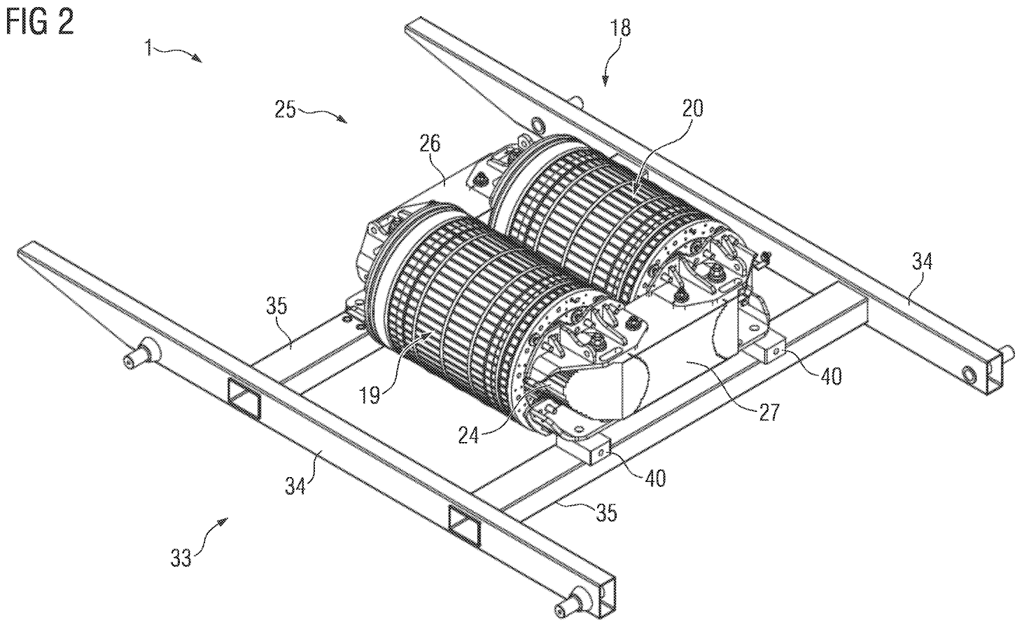

FIG. 2 shows the electrical appliance according to FIG. 1 without a tank;

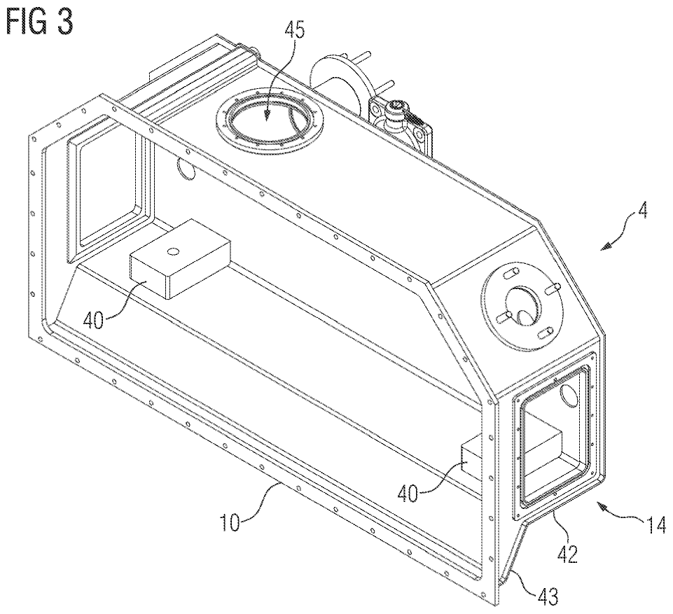

FIG. 3 shows an internal view of the rear end casing of the electrical appliance according to FIG. 1;

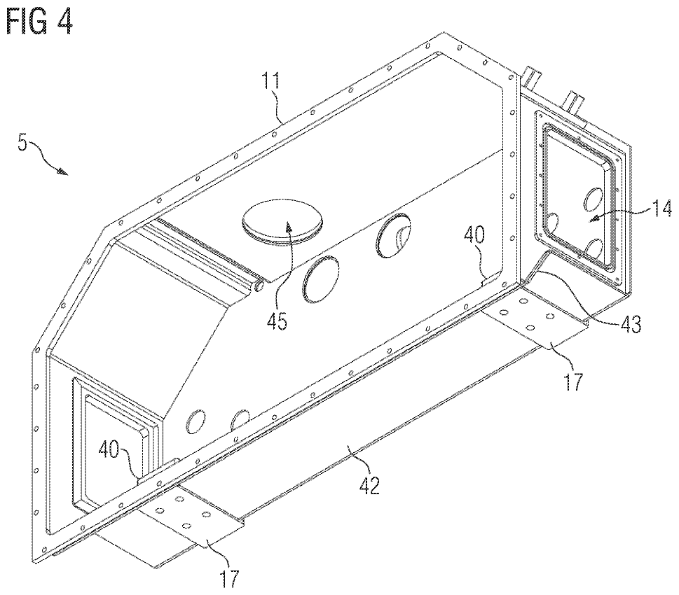

FIG. 4 shows an internal view of the front end casing of the electrical appliance according to FIGS. 1; and

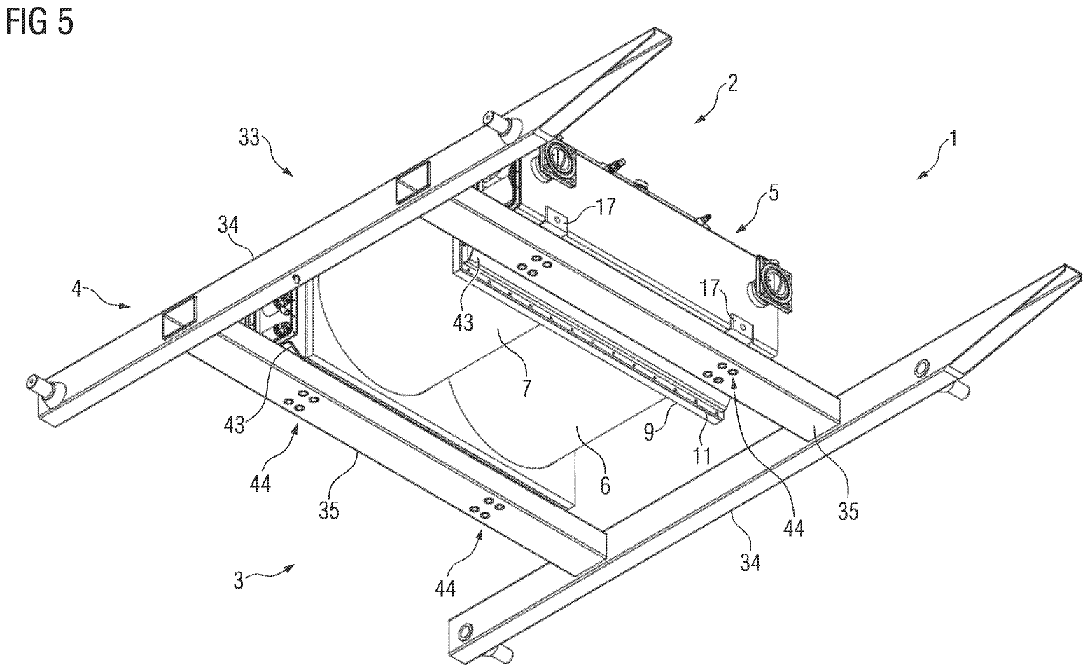

FIG. 5 shows the electrical appliance according to FIG. 1 from below, in each case highlighting this in a perspective view.

FIG. 1 shows an exemplary embodiment of the electrical appliance 1 in a perspective view, wherein the electrical appliance is embodied as a railway transformer 1. The railway transformer 1 comprises a tank 2 which could also be referred to as a housing, which comprises a central part 3, a rear end casing 4 and a front end casing 5. The central part 3 has two tubular portions 6 and 7 which delimit a circular-cylindrical internal cavity. The tubular portions 6 and 7 here extend in the axial direction or longitudinal direction. One flange portion 8 and 9 is in each case molded to both end sides of the tubular portions 6 and 7. Each flange portion 8 and 9, respectively, here is of a planar configuration and, by way of the respective external face thereof that faces the end casings, lies in a plane that extends in the radial direction.

For connecting to the central part, each end casing 4, 5 likewise has a flange portion 10 and 11 which is designed so as to correspond to the flange portions 8 and 9, respectively. In this way, the flange portions 8 and 10, or 9 and 11, respectively, are exactly opposite one another, wherein through bores by way of which the flange portions 9 and 11, or 8 and 10, respectively, can be screwed to one another are configured in the flange portions 10 and 11. The end casings 4 and 5 are designed so as to be box-shaped and have an end wall 12 which faces away from the respective flange portion, wherein lateral walls 13 extend between the end wall 12 and the flange portion 10 or 11, respectively. The rear end casing 4 is beveled at the corners so as to have an ideally small internal volume. The front end casing has an end wall 12 with beveled faces. This also serves for adapting the end casing to the design embodiment of the active part in this region and to thus minimize the internal volume of the tank 2, or of the respective end casing 5, respectively.

Each end casing 4 and 5 has hand holes 14 which are illustrated so as to be open in FIG. 1 and can be closed by a closure plate not illustrated. Sealing means ensure the necessary fluid-tight connection between the closure plate and the lateral wall 13 in which the hand hole 14 is configured.

The railway transformer, which is disposed in a horizontal orientation, furthermore comprises fastening means 33 which in FIG. 1 are embodied as support frames 33. The support frame 33, which in terms of the construction thereof is simple, comprises two longitudinal supports 34 which run so as to be mutually parallel, two transverse supports 35 which are likewise disposed so as to be mutually parallel extending between said longitudinal supports 34.

The tank 2 by way of the end casings 4 and 5 thereof rests on the transverse supports 35, wherein each end casing 4, 5 bears on the transverse support on a flat lower side. Each transverse support 35 is embodied as a hollow-section support and has two flat wide sides that point upward and downward, and two narrow sides that point toward the front and the rear. The flat lower side bears on the flat upper wide side of the transverse support 35 such that the respective end casing 4, 5 and the respective transverse support 35 bear on one another in a planar manner. An incline extends from the lower side of the end casing toward the flange portion 10 or 11, respectively. This incline lies opposite the narrow side of the respective transverse support 35 and thus forms a counter bearing. An axial movement of the tank 2 on the support frame is thus limited.

It can be seen that, apart from the transverse supports, the longitudinal supports 34 are also composed of hollow sections. Furthermore, fastening bolts 36 which serve for fastening the support frame to a rail vehicle not illustrated protrude from the longitudinal supports 34 in the orthogonal direction.

FIG. 2 shows the railway transformer 1 according to FIG. 1 without the tank 2 so as to obtain a view onto the active part 18 that is disposed in the tank. The active part 18 disposed in the tank 2 comprises two winding assemblies 19 and 20 which have in each case windings that are disposed so as to be mutually concentric. In this way, each winding assembly 19 and 20 comprises an outer primary winding and inner secondary winding which is disposed so as to be concentric with the primary winding. Furthermore provided in the interior of the primary winding is a concentrically disposed auxiliary operative winding. A core limb 24 of a core 25 extends through each winding assembly, wherein the two parallel core limbs 24 are connected to one another by a lower yoke 26 and an upper yoke 27 such that a circumferentially closed ferromagnetic circuit is formed. The core 25 is composed of laminations which bear on one another in a planar manner and are mutually compressed by a clamping frame on the lower yoke 26 and the upper yoke 27, respectively. The bracing or compressing of laminations bearing on one another in a planar manner is however known to the person skilled in the art such that no explanations in more detail are required at this point.

The construction composed of the press frame and the yoke bears on spacers 40 which in turn are fastened to the transverse supports 35 of the support frame 33. The spacers 40 here are disposed within the end casings 4 or 5, respectively, as will be explained in more detail hereunder.

With this construction, the weight of the active part 18 is introduced into the support frame 33 exclusively by way of the core 25 and the spacers 40. The introduction of forces into the central part of the tank 2 is avoided.

FIG. 3 shows the end casing 4 from the inside, in a perspective illustration. It can be seen that the end casing has through bores 45 for introducing feedthroughs and other connectors. The hand openings 14 can moreover be seen again. The end casing 4 furthermore forms a flat lower side 42 in which said end casing 4 bears in a planar manner on the upper wide side of the transverse support 35. An oblique side 43 in the form of a wall running obliquely in relation to the lower side 43 runs so as to proceed from the lower side 42. The oblique side forms a counter bearing in relation to the transverse support 35 and in this way prevents any undesirable axial movement of the tank 2 on the support frame 33.

The spacers 40 are disposed in the interior of the end casing 4. It can furthermore be seen that the flange portion 10 of the end casing 4 has through bores.

FIG. 4 in a perspective illustration shows the end casing 5; it can be seen in particular here that the spacers 40, which are disposed within the end casing 5, are fixedly connected to the reinforcement part 17, wherein the reinforcement part 17 in turn is fixedly connected to the transverse support 35. In this way, the spacers 40 can now be connected to the clamping frame or to the upper or lower yoke of the active part, respectively, by way of an expedient connection, for example a screw connection or any other mechanical connection, such that a fixed connection is established between the transverse support and the active part of the railway transformer. Therefore, the forces of the dead weight of the active part are introduced into the transverse support 35 of the support frame 33 by way of the core 25, optionally by way of the clamping frame into the spacers 40 and the fastening parts 14.

FIG. 5 shows the railway transformer 1 in a perspective illustration from below. It can be seen that the transverse supports 35 of the support frame have a mutual spacing, the latter making it possible for the tank 2 to be placed onto the support frame 33 such that the flange portions 8 and 10, or 9 and 11, respectively, are disposed between the transverse supports 35. The oblique portion 43 here bears on the narrow side of the respective transverse support 35 such that the latter forms a counter bearing so as to prevent an axial movement of the tank 2. It can moreover be seen that the transverse support 35 has a set of four through bores 44 in order for the reinforcement part 17 to be fixedly connected to the transverse support 35. The connection is performed, for example, by an expedient screw connection such that a locationally fixed mechanical connection between the tank 2 and the support frame 33 of the railway transformer 1 is established.

1-13. (canceled)

14. An electrical appliance for connection to a high voltage, the electrical appliance comprising:
an active part having a magnetizable core and a winding assembly enclosing a core portion of said core, said winding assembly having windings that are inductively coupled to one another; and
a tank to be filled with an insulating fluid and completely enclosing said active part, said tank having two end casings and a central part disposed between said end casings;
said active part being mechanically connected to said tank only at said end casings, and said end casings being supported on a fastener; and
said central part being made from a lightweight material.

15. The electrical appliance according to claim 14, wherein said fastener comprises a support frame.

16. The electrical appliance according to claim 15, wherein said support frame has two longitudinal supports and two transverse supports extending between said longitudinal supports, and wherein each of said end casings is supported on a respective one of said transverse supports.

17. The electrical appliance according to claim 14, wherein said core has two mutually parallel core limbs that are each enclosed by a winding assembly, and said core limbs are connected to one another by a lower yoke and an upper yoke.

18. The electrical appliance according to claim 17, wherein said lower yoke and said upper yoke are in each case connected to said lower and upper end casings by way of spacers, and wherein said spacers are disposed in an interior of the respective said end casing.

19. The electrical appliance according to claim 18, wherein each spacer is connected to a fastening plate disposed outside the respective said end casing.

20. The electrical appliance according to claim 19, wherein each fastening plate is connected to said fastener.

21. The electrical appliance according to claim 14, wherein said end casings are formed of a metal or a metal alloy.

22. The electrical appliance according to claim 21, wherein said end casings are formed of steel.

23. The electrical appliance according to claim 14, wherein said end casings are box-shaped casings.

24. The electrical appliance according to claim 14, wherein said end casings have a shape that is complementary to a portion of said active part lying opposite thereof.

25. The electrical appliance according to claim 14, wherein at least one of said end casings is formed with at least one of a viewing window or a hand opening.

26. The electrical appliance according to claim 14, wherein said central part has two planar flange portions and two hollow members extending therebetween, wherein each flange portion is mechanically and releasably connected to a flange portion of one of said end casings, and wherein sealing means are disposed between said flange portions.

27. The electrical appliance according to claim 26, wherein at least one end casing for a transverse support of said fastener, on which said end casing bears, forms a counter bearing for delimiting a movement of said tank in an axial direction.
